(19) United States
(12) Patent Application Publication
(10) Pub. No.: US 2014/0345864 A1
(43) Pub. Date: Nov. 27, 2014

(54) METHOD FOR PRODUCING COATED PROPPANTS

(71) Applicant: ASHLAND-SÜDCHEMIE-KERNFEST GMBH, Hilden (DE)

(72) Inventors: Reinhard Winter, Wulfrath (DE); Peter Kuhlmann, Wulfrath (DE); Lars Pollmann, Wuppertal (DE)

(73) Assignee: Ashland-Sudchemie-Kernfest GMBH, Hilden (DE)

(21) Appl. No.: 14/365,495

(22) PCT Filed: Dec. 14, 2012
(86) PCT No.: PCT/EP2012/075552

§ 371 Date: Jun. 13, 2014

(30) Foreign Application Priority Data
Dec. 15, 2011 (DE) 10 2011 121 254.3

(51) Int. Cl. C09K 8/80; C09K 8/62; E21B 43/267

(52) U.S. Cl. CPC C09K 8/805; E21B 43/267; C09K 8/62
USPC 166/280.2; 427/212; 507/219

(57) ABSTRACT

The present invention relates to a process for the production of coated proppants as well as proppants obtainable by such a process, uses thereof and processes using the proppants. The process for the production of coated proppant comprises the following steps:
(a) mixing a proppant with a polyol component and an isocyanate component, wherein the polyol component consists of one or more polyol compounds and optionally one or more other hydroxy group-containing compounds, and wherein the polyol component does not contain any phenolic resin,
   wherein the isocyanate component consists of one or more isocyanates having at least 2 isocyanate groups and optionally other isocyanate group-containing compounds, and
   wherein x parts by weight of the isocyanate component are used with respect to 100 parts by weight of the polyol component, with x being about 105% to about 550% of the isocyanate value defined below:

$$isocyanate value = \frac{42 \cdot 100 \cdot OH content ( \% ) of the polyol component}{17 \cdot NCO content ( \% ) of the isocyanate component}$$

(b) curing the mixture obtained in step (a) by treatment with a catalyst; and
(c) optionally repeating steps (a) and (b) one or more times,
   wherein as a proppant in step (a) the mixture obtained in the preceding step (b) or the proppant isolated therefrom is used as a proppant,
   wherein the polyol component in step (a) is the same as or different from the polyol component used in the previous step (a), and
   wherein the isocyanate component in step (a) is the same as or different from the isocyanate component used in the previous step (a).

The present invention relates to a process for the production of coated proppants, as well as proppants obtainable according to this process, uses thereof and processes using the proppants.

In order to improve efficiency during the extraction of crude oil and natural gas, a so-called frac process is employed. By pressing liquid (so-called frac liquid) into the rock layer containing crude oil and natural gas, fractures (fracs) are created.

This frac liquid is usually water gelled with polymers. In order to keep these artificially generated fracs open permanently, solid, more or less spherical materials, such as e.g. ceramic spheres or sand, which are referred to as proppants (support materials), are added to the frac liquid. These proppants are flushed into the frac with the frac liquid. Subsequently, the gel is broken and removed. That way, porous layers are created in the oil- or gas-containing underground which increase the flow and production capacity of the well. The frac process is also used to increase the efficiency of geothermal facilities.

The porous layers have to withstand the pressure of the surrounding rocks and should consistently guarantee a high degree of permeability and porosity. At high flow rates of the occurring oil or gas, there is the additional danger that the proppants are washed out of the artificially generated frac and that the frac closes again. The washed out proppants furthermore impede the transport and processing of the extracted crude oil and natural gas since they are abrasive and can damage or clog valves and pipelines. The washing out of the proppants from the frac is referred to as “flowback”.

In order to prevent flowback and to additionally increase the pressure resistance of the proppants, these usually mineral, round or granular materials are often coated with synthetic resins, such as e.g. phenolic resin, epoxy resin, polyurethane phenolic resin, furan resin, etc. Coated proppants and processes for their production are known e.g. from US 2002/0048676, US 2003/0131998, US 2003/0224165, US 2005/0019574, US 2007/0161515, US 2008/0230223, WO 2010/049467, U.S. Pat. No. 4,920,192, U.S. Pat. No. 5,048,608 and U.S. Pat. No. 5,199,491. By means of special formulations, attempts have been made to achieve a fixation (adhesion) of the proppants in the rock fracture in order to avoid a washing out of the proppants from the frac. This effect is referred to as “flowback control”.

The proppants are usually fixed by way of postcuring of the coating. This means that during the coating, storage and introduction of the proppants, the coating resin must not cure completely (b-stage). The coated proppants are free flowing but the coating resin is still slightly thermoplastic. The final curing should not take place until the proppants have been placed in the frac. This curing takes place under the pressure and temperature conditions prevailing therein.

Phenolic resin-coated proppants were produced in the prior art by curing phenolic resin prepolymers on the proppants. Due to the temperatures required for curing, an emission of phenols and/or formaldehyde will occur during this process. In use, such conventional proppants also exhibit disadvantages in that in the temperature and pressure conditions prevailing in the frac, phenolic decomposition products of the coating resins are released, which is undesirable from an ecological point of view. Thus, considerations have been made to limit or prohibit the use of such proppants. With polyurethane resin-coated proppants containing a phenolic resin as a polyol component, phenolic components may also be washed out under the conditions prevailing in the frac, which contributes to environmental burden. For this reason, one object underlying the present invention is to provide coated proppants which avoid such problems and exhibit a coating with good chemical and/or thermal resistance.

This object is achieved by the present invention which provides a process for the production of a coated proppant comprising the following steps:

(a) mixing a proppant with a polyol component and an isocyanate component,
wherein the polyol component consists of one or more polyol compounds and optionally one or more other hydroxy group-containing compounds and wherein the polyol component does not contain any phenolic resin,
wherein the isocyanate component consists of one or more isocyanates having at least 2 isocyanate groups and optionally one or more other isocyanate group-containing compounds, and
wherein x parts by weight of the isocyanate component are used with respect to 100 parts by weight of the polyol component, with x being about 105% to about 550%, preferably about 130% to 450%, more preferably about 150% to about 350%, even more preferably about 170% to about 300%, of the isocyanate value defined below:

$$isocyanante value = \frac{42 \cdot 100 \cdot OH content ( \% ) of the polyol component}{17 \cdot NCO content ( \% ) of the isocyanate component}$$

(b) curing the mixture obtained in step (a) by treatment with a catalyst; and
(c) optionally repeating steps (a) and (b) one or more times,
wherein, as the proppant, the mixture obtained in the preceding step (b) or the proppant isolated therefrom is used as a proppant in step (a),
wherein, when step (a) is repeated, the polyol component is the same as or different from the polyol component used in the previous step (a), and
wherein, when step (a) is repeated, the isocyanate component is the same as or different from the isocyanate component used in the previous step (a).

The invention furthermore relates to coated proppants obtainable by this process as well as uses of the coated proppants and processes using the coated proppants.

The process according to the present invention for the production of coated proppants is described in detail in the following.

### Step (a) of the Process for the Production of Coated Proppants

In step (a) of the process according to the present invention, a proppant is mixed with a polyol component and an isocyanate component.

The proppants to be coated are not particularly restricted and can be selected from the proppants known in the art. Examples include sand, ceramic particles (e.g. alumina, silica, titania, zinc oxide, zirconia, ceria, manganese dioxide, iron oxide, calcium oxide or bauxite) or other granular materials. The proppants to be coated preferably have an average particle size of about 50 μm to about 3000 μm, more preferably about 100 μm to about 2000 μm.

The polyol component consists of one or more polyol compounds and optionally one or more other hydroxy group-containing compounds. The polyol component contains essentially no phenolic resin. Within the scope of the present invention, “essentially no” or the statement that the polyol component is free from a specific compound means that the polyol component contains less than 1% by weight, preferably less than 0.5% by weight, more preferably 0% by weight of the respective compound.

Since all hydroxy group-containing compounds of the polyurethane coating are considered to be constituents of the polyol component, the feature according to which the polyol component does not contain any phenolic resin means that the entire polyurethane coating does not contain any phenolic resin. So far, it had been assumed that due to its high reactivity with isocyanates, a phenolic resin component is necessary to be able to efficiently produce polyurethane-coated proppants. It has, however, surprisingly been found that coatings without phenolic resins can not only be easily produced, but, moreover, exhibit improved chemical and/or thermal resistance as compared with coatings containing phenolic resins. Thus, the process according to the present invention provides coated proppants which can be used without giving rise to ecological concern and, moreover, due to the stability of their coating, provide further advantages during use.

Thus, it is essential to the present invention that the polyol component and, thus, the entire polyurethane coating contains essentially no phenolic resin. In a preferred embodiment, the polyol component contains essentially no or no compounds having phenolic OH groups, i.e., OH groups which are bound to an aromatic ring.

Apart therefrom, the polyol compounds which can be used in the polyol component are not particularly restricted and include all hydroxy group-containing compounds which contain at least two, e.g. two, three or four primary and/or secondary hydroxy groups.

With regard to good processability it is advantageous to use polyol compounds which are liquid at normal pressure (101.3 kPa) and temperatures of 40° C. or more, e.g. at 40° C. to 120° C., preferably of 50° C. or more, e.g. at 50° C. to 120° C. and in particular at 60° C. or more, e.g. 60 to 120° C. Their viscosity (measured in accordance with EN ISO 2884-2 by means of a rotational viscosimeter) at 50° C. is preferably not higher than 10 Pa·s.

Examples of preferred polyol compounds are aliphatic polyether polyols, polyester polyols such as castor oil or modified castor oil, polyacrylate polyols, hydroxy-modified vegetable oils, aliphatic hydrocarbon polyols or mixtures of these compounds.

Examples of aliphatic polyether polyols include polyalkylene ether polyols such as polyethylene ether polyols and polypropylene ether polyols, and polyether polyols which in addition to the polyether chains comprise tertiary amine units which serve as initiators or branching site, such as alkoxylated ethylene diamine. Such polyether polyols are, e.g., available under the trade names Desmophen from the company Bayer or under the trade name Voranol from the company Dow Chemicals. Preferred examples of alphatic polyether polyols are diethylene glycol, triethylene glycol and higher homologues (e.g. those wherein n=3 to 8, wherein n represents the number of the oligomerized glycol units), dipropylene glycol, tripropylene glycol and higher homologues (e.g. those wherein n=3 to 8, wherein n represents the number of the oligomerized glycol units), alcoxylated glycerol, such as polyethoxylated glycerol or polypropoxylated glycerol, and alcoxylated amine, such as polyethoxylated ethylene diamine or polypropoxylated ethylene diamine.

Preferred polyols for the polyol component within the scope of the present invention are the aliphatic polyether polyols as well as castor oil (CAS 8001-79-4). Derivatives of castor oil which are obtainable by hydroxylating castor oil, so-called hydroxy-modified castor oils, may also preferably be used. Such derivatives of castor oil are, e.g., available under the trade name Neukapol from the company Altropol.

Aliphatic hydrocarbon polyols include, e.g., glycerol, ethylene glycol, propylene glycol, butane diols or hexane diols.

In addition to the polyol compound, the polyol component can also comprise other hydroxy group-containing compounds.

The optionally present other hydroxy group-containing compounds are not particularly restricted and can be selected from hydroxy group-containing compounds known in the art of polyurethane chemistry, which are, e.g., used to control the chain length of the polyurethane, e.g. alcohols which are not polyol compounds. Since monovalent alcohols may also react with isocyanates, they are taken into consideration here as a constituent of the polyol component when calculating the isocyanate value.

The amount of other hydroxy group-containing compounds depends on the desired properties of the proppant coating and can be selected accordingly by the person skilled in the art. Typically, however, it is small and is at most 5 wt.-%, preferably at most 3 wt.-%, based on the total amount of all compounds contained in the polyol component as 100 wt.-%.

The isocyanate component consists of one or more isocyanates having at least 2 isocyanate groups, e.g. two, three or four isocyanate groups, and optionally other isocyanate group-containing compounds.

The isocyanate having at least 2 isocyanate groups is not particularly restricted and can be selected from the isocyanate groups known in the art.

Preferably, an aliphatic or aromatic isocyanate having at least 2 isocyanate groups (e.g. a diisocyanate, triisocyanate or tetraisocyanate), or an oligomer or a polymer thereof can be used as an isocyanate having at least 2 isocyanate groups. These isocyanates having at least 2 isocyanate groups can also be carbocyclic or heterocyclic and/or comprise one or more heterocyclic groups.

The isocyanate having at least 2 isocyanate groups is preferably a compound having the formula (III) or a compound having the formula (IV):

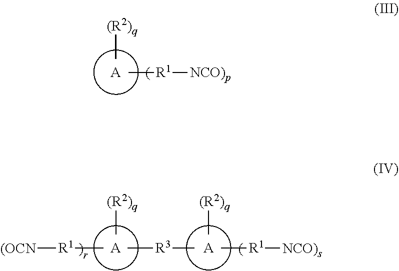

In formulae (III) and (IV), each A is independently aryl, heteroaryl, cycloalkyl or heterocycloalkyl. Preferably, each A is independently aryl or cycloalkyl. More preferably, each A is independently aryl. Even more preferably, each A is phenyl.

The aryl is preferably phenyl, naphthyl or anthracenyl, more preferably phenyl.

The heteroaryl is preferably a heteroaryl having 5 or 6 ring atoms, 1, 2, or 3 of which are independently an oxygen, sulfur or nitrogen atom and the remaining ring atoms are carbon atoms. More preferably, the heteroaryl is selected from pyridinyl, thienyl, furyl, pyrrolyl, imidazolyl, pyrazolyl, pyrazinyl, pyrimidinyl, pyridazinyl, oxazolyl, isoxazolyl or furazanyl.

The cycloalkyl is preferably a C₃₋₁₀-cycloalkyl, more preferably a C₅₋₇-cycloalkyl.

The heterocycloalkyl is preferably a heterocycloalkyl having 3 to 10 ring atoms (more preferably 5 to 7 ring atoms), one or more of which (e.g. 1, 2 or 3) are each independently an oxygen, sulfur or nitrogen atom and the remaining ring atoms are carbon atoms. More preferably, the heterocycloalkyl is selected from tetrahydrofuranyl, piperidinyl, piperazinyl, aziridinyl, azetidinyl, pyrrolidinyl, imidazolidinyl, morpholinyl, pyrazolidinyl, tetrahydrothienyl, octahydroquinolinyl, octahydroisoquinolinyl, oxazolidinyl or isoxazolidinyl. Even more preferably, the heterocycloalkyl is selected from tetrahydrofuranyl, piperidinyl, piperazinyl, pyrrolidinyl, imidazolidinyl, morpholinyl, pyrazolidinyl, tetrahydrothienyl, oxazolidinyl or isoxazolidinyl.

In formulae (III) and (IV), each R¹ is independently a covalent bond or C₁₋₄-alkylene (e.g. methylene, ethylene, propylene or butylene). Preferably, each R² is a covalent bond.

In formulae (III) and (IV), each R² is independently halogen (e.g. F, Cl, Br or I), C₁₋₄-alkyl (e.g. methyl, ethyl, propyl or butyl) or C₁₋₄-alkyoxy (e.g. methoxy, ethoxy, propoxy or butoxy). Preferably, each R² is independently a C₁₋₄-alkyl. More preferably, each R² is methyl.

In formula (IV), R³ is a covalent bond, a C₁₋₄-alkylene (e.g. methylene, ethylene, propylene or butylene) or a group —(CH₂)_{R31}—O—(CH₂)_{R32}—, wherein R31 and R32 are each independently 0, 1, 2 or 3. Preferably, R³ is a group —CH₂— or a group —O—.

In formula (III), p is 2, 3 or 4, preferably 2 or 3, more preferably 2.

In formulae (III) and (IV), each q is independently an integer from 0 to 3, preferably 0, 1 or 2. If q is 0, the corresponding group A does not have a substituent R², i.e. instead of R² it has hydrogen atoms.

In formula (IV), r and s are each independently 0, 1, 2, 3 or 4, wherein the sum of r and s is 2, 3 or 4. Preferably, r and s are each independently 0, 1 or 2, wherein the sum of r and s is 2. More preferably, r is 1 and s is 1.

Examples of the isocyanate having at least 2 isocyanate groups include:

Toluene-2,4-diisocyanate, toluene-2,6-diisocyanate, 1,5-naphthalene diisocyanate, cumene-2,4-diisocyanate, 4-methoxy-1,3-phenyl diisocyanate, 4-chloro-1,3-phenyl diisocyanate, diphenylmethane-4,4-diisocyanate, diphenylmethane-2,4-diisocyanate, diphenylmethane-2,2-diisocyanate, 4-bromo-1,3-phenyl diisocyanate, 4-ethoxy-1,3-phenyl diisocyanate, 2,4′-diisocyanate-diphenylether, 5,6-dimethyl-1,3-phenyl diisocyanate, 2,4-dimethyl-1,3-phenyl diisocyanate, 4,4-diisocyanatodiphenylether, 4,6-dimethyl-1,3-phenyl diisocyanate, 9,10-anthracene diisocyanate, 2,4,6-toluene triisocyanate, 2,4,4′-triisocyanatodiphenylether, 1,4-tetramethylene diisocyanate, 1,6-hexamethylene diisocyanate, 1,10-decamethylene diisocyanate, 1,3-cyclohexylene diisocyanate, 4,4′-methylene-bis-(cyclohexylisocyanate), xylene diisocyanate, 1-isocyanato-3-methylisocyanate-3,5,5-trimethylcyclohexane (isophorone diisocyanate), 1-3-bis(isocyanato-1-methylethyl)-benzene (m-TMXDI), 1,4-bis(isocyanato-1-methylethyl)-benzene (p-TMXDI), oligomers or polymers of the above-mentioned isocyanate compounds, or mixtures of two or more of the above-mentioned isocyanate compounds or oligomers or polymers thereof.

The isocyanate having at least 2 isocyanate groups is more preferably toluene diisocyanate, diphenylmethane diisocyanate, an oligomer on the basis of toluene diisocyanate or an oligomer on the basis of diphenylmethane diisocyanate.

According to the present invention, the proppants to be coated are treated with an excess of isocyanate component compared to the polyol component. Therefore, in step (a), x parts by weight of the isocyanate component are used with respect to 100 parts by weight of the polyol component. x equals about 105% to about 550%, preferably about 130% to about 450%, more preferably about 150% to about 350%, even more preferably about 170% to about 300%, of the isocyanate value defined below (i.e. x is a number which is about 105% to about 550%, preferably about 130% to about 450%, more preferably about 150% to about 350%, even more preferably about 170% to about 300%, of the isocyanate value defined below):

$$isocyanate value = \frac{42 \cdot 100 \cdot OH content ( \% ) of the polyol component}{17 \cdot NCO content ( \% ) of the isocyanate component}$$

The isocyanate value defines the amount of isocyanate component which is equivalent to 100 parts by weight of the polyol component. The NCO content (%) of the isocyanate component is determined according to DIN ISO 53185. For determining the OH content (%) of the polyol component, at first the so-called OH number is determined according to DIN ISO 53240 as mg KOH/g, and this value is divided by 33 in order to calculate the OH content.

Thus, in step (a), an excess of NCO groups in the isocyanate component of about 5 to about 450%, preferably about 30 to about 350%, more preferably about 50 to about 250%, even more preferably about 70% to about 200%, based on the OH groups in the polyol component is used.

It is essential for the process for coating proppants according to the present invention that an excess of isocyanate component compared to the polyol component be used, as described above. In this way, sufficient isocyanate groups are available for the formation of dimers and trimers postulated above. Moreover, a reduction in the undesired flowback effect can be achieved in this way.

Due to the excess of an isocyanate component in step (a) of the process according to the present invention, the coated proppants obtainable by this process comprise an amount of free isocyanate groups in the coating. This allows for controlled postcuring of the coating in the frac as the free terminal isocyanate groups of the coating react with water present in the frac under the prevailing temperature and pressure conditions, whereby (poly-)urea structures are formed. It is assumed that the isocyanate groups react with water to form amino groups, whereby CO₂ is released, which amino groups then react with other free isocyanate groups in the coating to form urea structures. Due to the postcuring of the coating in the frac, the proppants adhere and a porous, pressure-resistant, stable layer having a high degree of permeability is formed. Thus, the flowback effect can be reduced.

A higher excess of isocyanate component usually results in superior flowback control properties. Thus, by modifying the mixing ratio of isocyanate component and polyol component, the properties of the proppant coating can be largely adapted to the desired specific demands.

Furthermore, one or more additives can be mixed with the proppant, the polyol component and the isocyanate component in step (a).

These additives are not particularly restricted and can be selected from the additives known in the art.

If any of these additives comprises a hydroxy group, it has to be considered another hydroxy group-containing compound as described above in connection with the polyol component. If any of these additives comprises an isocyanate group, it has to be considered another isocyanate group-containing compound. Additives having hydroxy groups and isocyanate groups can be simultaneously considered other hydroxy group-containing and other isocyanate group-containing compounds.

Solvents, plasticizers, wetting agents, molecular sieves for removing reaction water, diluents, and/or adhesion promotors (such as silanes) can e.g. be used as additives.

Silanes, in particular, can be used to improve the adhesion of the coating resin to the proppant. Silanes can be added in step (a) as an additive, but they can also be chemically reacted with the reactive constituents of the polyol component or the isocyanate component. Functional silanes, such as e.g. aminosilanes, epoxy-, aryl- or vinylsilanes, are commercially available and can be used as an additive, as described above, or reacted with the reactive constituents of the polyol component or the isocyanate component. Aminosilanes and epoxysilanes in particular can be easily reacted with the isocyanate component.

The process for the production of coated proppants according to the present invention can be carried out without the use of solvents. Accordingly, in one embodiment of the process, the mixture obtained in step (a) is solvent-free or substantially solvent-free. The mixture is substantially solvent-free if it contains less than 20 wt.-%, preferably less than 10 wt.-%, more preferably less than 5 wt.-%, even more preferably less than 3 wt.-%, and even more preferably less than 1 wt.-% of solvent, based on the total weight of the components of the mixture.

Preferably, the process is carried out without the use of organic solvents. In this case, the mixture obtained in step (a) is free or substantially free of organic solvents. The mixture is substantially free of organic solvents if it contains less than 20 wt.-%, preferably less than 10 wt.-%, more preferably less than 5 wt.-%, even more preferably less than 3 wt.-%, and even more preferably less than 1 wt.-% of organic solvents, based on the total weight of the components of the mixture.

In step (a), proppant, polyol component, isocyanate component and optional additives can be mixed using any desired process.

A mixer can be used for this purpose which is not particularly restricted and can be selected from mixers known in the art. For example, a kneader mixer or a stirrer mixer can be used. For example, a drum mixer, a pan mixer, an in-line mixer, a trough mixer or a cone mixer can be used. The easiest mixing process employs a rotating drum. A screw can, for example, be used as a continuous mixer.

Mixing can be carried out as a continuous or a discontinuous process. In suitable mixers it is, for example, possible to continuously add the polyol component, the isocyanate component and optional additives to the proppants and at the same time to treat the mixture with a catalyst as described in step (b), preferably to introduce the catalyst as a gas. For example, the polyol component, the isocyanate component and the optional additives can be mixed in a continuous mixer (such as a screw) with the proppants and an amine (e.g. an amine/air mixture or a nitrogen/amine mixture as described below) can be introduced.

Preferably, the proppant, polyol component, isocyanate component and the optional additives are mixed homogenously. Thus, the polyol component and the isocyanate component are evenly distributed on the surface of the proppants. Preferably, the proppant, polyol component, isocyanate component and optional additives are agitated during the entire mixing process.

It is also possible to connect several mixers in series or to coat the proppants in several passes through a single mixer.

The temperature at which step (a) is carried out is not particularly restricted. Preferably, step (a) is carried out at the same temperature as step (b), e.g. at a temperature of about 40° C. to about 150° C., more preferably at a temperature of about 60° C. to about 120° C.

### Step (b) of the Process for the Production of Coated Proppant

In step (b), the mixture obtained in step (a) is treated with a catalyst and thus cured.

The catalyst is not particularly restricted and can be selected from the catalysts known in the art which catalyze the reaction of hydroxy group-containing compounds and isocyanate group-containing compounds to form (poly-)urethanes. Suitable catalysts can, for example, be selected from nitrogen-containing compounds, organometallic compounds (in particular from organotin, organoiron, organobismuth or organomercury compounds) or combinations thereof. The organometallic compounds are preferably used in combination with one or more amines, e.g. the amines described below.

Preferably, an amine, an organotin compound or a combination thereof is used as a catalyst.

The amine is preferably a tertiary amine or a nitrogen-containing heterocycle which may optionally be substituted, such as an optionally substituted pyridine or an optionally substituted imidazole. As the tertiary amine, preferably a compound having the formula (R)₃N is used, wherein each R is independently a (C₁₋₆)-hydrocarbon group which is optionally substituted with one or more hydroxy groups. Preferably, each R is independently a (C₁₋₄-alkyl group, a (C₂₋₄-alkenyl group or a (C₂₋₄-alkynyl group, wherein the alkyl group, alkenyl group or alkynyl group is optionally substituted with one or more hydroxy groups. More preferably, each R is independently (C₁₋₄)-alkyl which is optionally substituted with a hydroxy group. Trimethylamine, triethylamine, dimethylethylamine, dimethylisopropylamine, dimethylpropylamine, triethanolamine, vinylimidazole, 1,4-diazabicyclo[2.2.2]octane (DABCO), 4-(3-phenylpropyl)pyridine or a mixture thereof are particularly preferred as a catalyst.

The organotin compound is not particularly restricted and can be selected from the organotin compounds known in the art of polyurethane chemistry. The organotin compound is preferably used in combination with one or more amines, such as e.g. the amines described above. Preferably, the organotin compound is a compound having the formula (R¹)₂Sn(R²)₂, wherein each R¹ is independently a (C₁₋₂₀)-hydrocarbon-carbonyloxy group and each R² is independently a (C₁₋₈)-hydrocarbon group. Preferably, each R¹ is independently a (C₁₋₂₀)-alkyl-carbonyloxy group, a (C₂₋₂₀)-alkenyl-carbonyloxy group or a (C₂₋₂₀)-alkynyl-carbonyloxy group. More preferably, each R¹ is independently a (C₉₋₁₃)-alkyl-carbonyloxy group. Each R² is preferably independently a (C₁₋₈)-alkyl group, a (C₂₋₈)-alkenyl group or a (C₂₋₈)-alkynyl group, more preferably, each R² is independently a (C₂₋₆)-alkyl group. Accordingly, dibutyltin dilaurate can, for example, preferably be used as a catalyst.

Preferably, the mixture obtained in step (a) is supplied with a gaseous catalyst in step (b). A mixture of a carrier gas (e.g. nitrogen or air) and one of the catalysts described above can, for example, be used as a gaseous catalyst. For this purpose, the carrier gas, such as nitrogen or air, can, for example, be passed through a catalyst present in a liquid state. Preferably, a nitrogen/amine mixture or an air/amine mixture is used as a gaseous catalyst, wherein the amine contained in the nitrogen/amine mixture or the air/amine mixture is, for example, a low-boiling amine (preferably an amine boiling at a temperature of 90° C. or less, more preferably 70° C. or less, even more preferably 40° C. or less). For example trimethylamine, triethylamine, dimethylethylamine, dimethylpropylamine, dimethylisopropylamine or a mixture thereof are particularly preferred. The amine used as a gaseous catalyst can be collected e.g. using acid scrubbers. The air in the air/amine mixture is preferably dry air, more preferably anhydrous air.

The reaction time in step (b) is not particularly restricted and depends on the type and amount of catalyst used therein. When supplying a gaseous catalyst, in some embodiments a reaction time of less than 1 minute can be selected.

The treatment with a catalyst in step (b) is carried out such that curing occurs due to the reaction of the isocyanate component and the polyol component, resulting in the formation of polyurethane structures. In order to ensure postcuring of the coating in the frac and hence a reduction of the flowback effect, the free isocyanate groups in step (b) must not react with water and form urea structures. Thus, only partial curing is carried out in step (b).

The curing conditions in step (b) can be adjusted by a person skilled in the art in different ways such that hardly any reaction of the isocyanate groups with water in which urea structures are formed takes place. In a preferred embodiment, this is, for example, accomplished by carrying out the curing in step (b) at a temperature of about 40° C. to about 150° C., preferably from about 60° C. to about 140° C., more preferably from about 75° C. to about 130° C., even more preferably from about 80° C. to about 120° C. The pressure can be about 50 to about 200 kPa, preferably about 100 to about 150 kPa (e.g. at a standard pressure of about 101.3 kPa).

Although it is not intended to limit the present invention to a specific theory, it is assumed that the isocyanate groups of the isocyanate component react with each other in particular at higher processing temperatures, so that dimeric and trimeric isocyanate compounds, preferably trimeric isocyanate compounds, are produced. It is furthermore assumed that these dimeric and trimeric isocyanate compounds react with the polyol component to give polyurethanes which are chemically and/or thermally more stable, e.g. more stable against hydrolysis.

In another preferred embodiment, the curing in step (b) can, for example, be carried out under the exclusion of water or at a low water content. Hence, there is hardly any reaction of the isocyanate groups with water to form urea structures, either. In this case, the water content of the mixture obtained in step (a) is preferably less than 10 wt.-%, more preferably less than 5 wt.-%, even more preferably less than 2 wt.-%, even more preferably less than 1 wt.-%, even more preferably less than 0.5 wt.-%, even more preferably less than 0.2 wt.-%, based on the total weight of the mixture as 100 wt.-%. Such a low water content can, for example, be achieved by using the educts in step (a)—proppant, polyol component, isocyanate component and optional additives—in dried form, preferably in anhydrous form. Furthermore, as was described above, a gaseous catalyst in the form of a nitrogen/amine mixture or an air/amine mixture can be used, wherein the air in the air/amine mixture is preferably dry air, more preferred anhydrous air.

### Step (c) of the Process for the Production of Coated Proppant

Step (c) is optional. During step (c), the previous steps (a) and (b) are optionally repeated one or more times (e.g. 1-5 times, 2-4 times or 2-3 times), i.e. the coated and cured proppant obtained in step (b) is again mixed with a polyol component and an isocyanate component and the mixture is treated with a catalyst and thus cured. Thus, the thickness of the coating of the proppants can be adjusted.

In step (c), either the cured mixture obtained in step (b) can be used directly (i.e. the mixture obtained in step (b) can be mixed directly with the polyol component and the isocyanate component and subsequently treated with a catalyst), or only the coated and cured proppant is used, in which case it is isolated from the mixture obtained in step (b) and optionally cleaned.

In the single or repeated repetition of steps (a) and (b), the same or a different polyol component as that used in the previous step (a) can be used as a polyol component in step (a). Likewise, the same or a different isocyanate component as that used in the previous step (a) can be used as an isocyanate component in step (a). Furthermore, when steps (a) and (b) are repeated, the amounts of polyol component and isocyanate component can be modified.

In particular when the application weight of the coating resin is high, it is recommended to carry out a step-wise coating process by repeating steps (a) and (b) one or more times as described above, in order to avoid adhesion or agglomeration of the proppants during the coating process.

The amount of coating resin, i.e. the polyurethane resin applied to a proppant, is preferably about 0.5 to about 10 wt.-%, more preferably about 2 to about 5 wt.-%, of resin, based on the weight of the proppant as 100 wt.-%.

The coated proppants according to the present invention, which can be obtained by the process provided herein, exhibit an amount of free isocyanate groups in the coating. Without wanting to be restricted to a specific theory, it is assumed that the free isocyanate groups are embedded in the resin matrix of the coating and are only partially present at the surface of the coated proppants. It is therefore believed that during storage and during the introduction into a frac, hardly any reaction of the free isocyanate groups takes place. A substantial amount of reaction and thus postcuring only occurs under the elevated temperature and pressure conditions in the frac. The coated proppants according to the present invention are characterized by a good shelf life and they can therefore also be easily brought to the drilling location as a pre-coated material.

In addition, the coated proppants can be treated with wetting agents or auxiliary agents such as e.g. talcum or stearate, in order to improve their free flowing properties.

The present invention furthermore relates to a frac liquid comprising the coated proppants according to the present invention. Accordingly, the invention includes the use of the coated proppants in the production of crude oil or natural gas.

The frac liquid is not particularly restricted and can be selected from the frac liquids known in the art. Suitable frac liquids are, for example, described in “WC Lyons, G J Plisga: Standard handbook of petroleum and natural gas engineering; Gulf Professional Publishing; 2005”. The frac liquid can, for example, comprise water gelled with polymer, an oil-in-water emulsion gelled with polymer or a water-in-oil emulsion gelled with polymer. In a preferred embodiment, the frac liquid comprises the following components in the ratios given below: 1000 l water; 20 kg potassium chloride; 0.120 kg sodium acetate; 3.6 kg guar gum (water-soluble polymer); sodium hydroxide (as needed) for adjusting the pH value to 9 to 11; 0.120 kg sodium thiosulfate; and 0.180 kg ammonium persulfate.

The invention furthermore relates to a process for the production of crude oil or natural gas comprising injecting the coated proppants in a frac liquid (i.e. injecting a frac liquid which contains the coated proppants) into a rock layer containing crude oil or natural gas, or introducing the proppants into a frac in the rock layer containing crude oil or natural gas. The process is not particularly restricted and can be carried out in a manner known in the art.

Following the introduction of the coated proppants, a frac is formed in the rock layer containing crude oil or natural gas, and the coated proppants of the present invention undergo postcuring in the frac in the presence of water. The free isocyanate groups of the coated proppants react with water present in the frac under the prevailing temperature and pressure conditions, whereby urea structures are formed. It is assumed that the isocyanate groups react with water to form amino groups, whereby CO₂ is released, which amino groups then react with other free isocyanate groups in the coated proppants to form urea structures. The conditions under which the postcuring takes place can vary widely depending on the rock layer. Typical conditions are, for example, a pressure in the range of about 690 to about 100,000 kPa and a temperature in the range of about 50 to about 250° C. The postcuring of the coated proppants in the frac results in a porous, pressure-resistant, stable layer having a high degree of permeability. The individual particles adhere to each other. Thus, a reduction in the flowback effect can be achieved.

After postcuring in the frac, the coated proppants preferably comprise less than 90%, more preferably less than 80%, even more preferably less than 70%, even more preferably less than 60%, and even more preferably less than 50%, of the amount of free isocyanate groups present in the coating prior to the introduction of the proppants.

The term “comprise” used herein (as well as “contain”) is intended to mean that the mentioned components are comprised or contained, inter alia, while other components, which are not mentioned, may be contained as well. However, the term “comprise” (or “contain”) also encompasses the meaning of “consisting of”, i.e. the possibility that only the mentioned components are contained, without any other, undisclosed, components being present.

The term “about” used herein indicates that a slight deviation from the given value is possible. Unless defined otherwise, the term “about” refers to a possible deviation of ±10%, preferably ±5%, more preferably ±2%, even more preferably ±1%, of the given value. The given value itself is most preferred.

The examples below are intended to explain the present invention in more detail without restricting it in any way.

### EXAMPLES

3000 g of sand (H32 quartz works) were placed in a mixer and heated to the temperature given in the table using a hot air blower. The total amount of the coating resin (polyol and isocyanate) was calculated to be 3.5 wt.-% (105 g), based on the sand. The amount of the individual components polyol and isocyanate is calculated from the mixing ratio given in the following table.

3 g aminosilane and, if indicated in the table (mixture), catalyst (6 g Dabco 33 LV/0.2 g DBTL dibutyltin dilaurate) were added to the polyols listed.

The premixed polyol component was mixed with the preheated sand for 30 sec. Then, the isocyanate (oligomeric MDI having an NCO content of 30-33% and an average functionality of 2.5) was added within 20 sec. After further 20 sec of mixing, if indicated in the table (gassing), a dimethyl isopropyl amine/air mixture was introduced. For this purpose, dry air was passed through a gas washing bottle filled with the amine, saturated with amine in this way and introduced into the mixer.

When the mixer is operating, the coating cures in less than one minute and a flowable mixture is obtained.

The amount of coating resin obtained on the sand can be determined by means of the loss on ignition (LOI). The water and temperature resistance were determined via the decrease in the loss on ignition after treatment of the coated sand in an autoclave (48 h 130° C.; 2.7 bar, 1 part by weight of coated sand in 2 parts by weight of water).

The portions released from the coating can be determined via the decrease in loss on ignition upon treatment in the autoclave.

Determination of the loss on ignition (LOI) (corresponding to the resin content on the coated sand)

### Determination of the Loss on Ignition

(in accordance with DIN 18128)

Drying the coated sand for 2 h at 110° C. in a drying cabinet (constant weight).

Weighing in 2-3 g of sample into a porcelain crucible and annealing for 1 h at 625° C. in a muffle type furnace.

The loss on ignition (LOI) is calculated by weighing the sample before and after annealing and in accordance with the following formula:

$$LOI = \frac{( weight before annealing - weight after annealing ) \times 100}{weight before annealing}$$

The amounts of the components used as well as the test results obtained are given in the following table.

The following substances were used in this example:

Phenolic resin: composition in accordance with Example 2B of PCT/EP2011/070465 (in wt.-%):

polyether polyol 38; cardanol 23; phenolic resin 39;
modified castor oil: trade name Neukapol PN 1630, company Altropol
polyether polyol: trade name Desmophen 1380 BT, company Bayer AG propoxylated glycerol: trade name Voranol CP 300, company Dow Chemicals

| | | | | | | Loss on | |
|---|---|---|---|---|---|---|---|
| | | Mixing ratio | | | | ignition | |
| | | polyol/ | | Coating | Initial loss | after 48 h in | Loss |
| | Polyol base | isocyanate | Catalysis | temperature | on ignition | autoclave | in % |
| Comparative | Phenolic resin | 30/70 | Gassing | 30° C. | 3.42 | 2.91 | 14.91 |
| example 1 | | | | | | | |
| Comparative | Phenolic resin | 30/70 | Gassing | 70° C. | 3.48 | 2.97 | 14.65 |
| example 2 | | | | | | | |
| 1 | Castor oil | 50/50 | Gassing | 70° C. | 3.45 | 3.29 | 4.64 |
| 2 | Castor oil | 40/60 | Gassing | 70° C. | 3.48 | 3.37 | 3.16 |
| 3 | Castor oil | 30/70 | Gassing | 70° C. | 3.46 | 3.28 | 5.20 |
| 4 | Castor oil | 30/70 | Mixing | 70° C. | 3.41 | 3.29 | 3.52 |
| 5 | Modif. | 50/50 | Gassing | 70° C. | 3.48 | 3.3 | 5.17 |
| | castor oil | | | | | | |
| 6 | Modif. | 30/70 | Gassing | 70° C. | 3.46 | 3.33 | 3.76 |
| | castor oil | | | | | | |
| 7 | Polyether | 30/70 | Gassing | 70° C. | 3.51 | 3.13 | 10.83 |
| | polyol | | | | | | |
| 8 | Propoxylated | 30/70 | Gassing | 70° C. | 3.45 | 3.2 | 7.25 |
| | glycerol | | | | | | |
| 9 | Propoxylated | 30/70 | Mixing | 70° C. | 3.43 | 3.19 | 7.00 |
| | glycerol | | | | | | |

1. Process for the production of coated proppant, comprising the following steps:
(a) mixing a proppant with a polyol component and an isocyanate component,
wherein the polyol component consists of one or more polyol compounds and optionally one or more other hydroxy group-containing compounds, and wherein the polyol component does not contain any phenolic resin,
wherein the isocyanate component consists of one or more isocyanates having at least 2 isocyanate groups and optionally one or more other isocyanate group-containing compounds, and
wherein x parts by weight of the isocyanate component are used with respect to 100 parts by weight of the polyol component, with x being about 105% to about 550% of the isocyanate value defined below:
$$isocyanate value = \frac{42 \cdot 100 \cdot OH content ( \% ) of the polyol component}{17 \cdot NCO content ( \% ) of the isocyanate component} ;$$
(b) curing the mixture obtained in step (a) by treatment with a catalyst; and
(c) optionally repeating steps (a) and (b) one or more times,
wherein as a proppant in step (a) the mixture obtained in the preceding step (b) or the proppant isolated therefrom is used as a proppant,
wherein the polyol component in step (a) is the same as or different from the polyol component used in the previous step (a), and
wherein the isocyanate component in step (a) is the same as or different from the isocyanate component used in the previous step (a).

2. The process according to claim 1, wherein ceramic particles or sand is used as proppant.

3. The process according to claim 2, wherein ceramic particles selected from alumina, silica, titania, zinc oxide, zirconia, ceria, manganese dioxide, iron oxide, calcium oxide or bauxite are used as a proppant.

4. The process according to claim 2, wherein the ceramic particles or the sand have an average particle size of about 50 μm to about ca. 3000 μm.

5. The process according to claim 1, wherein the polyol component consists of an aliphatic polyether, a castor oil, modified castor oil or mixtures thereof.

6. The process according to claim 1, wherein the isocyanate having at least 2 isocyanate groups is a compound having the formula (III): 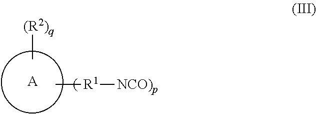
wherein:
A is an aryl, heteroaryl, cycloalkyl or heterocycloalkyl;
each R¹ is independently a covalent bond or C₁₋₄-alkylene;
each R² is independently halogen, C₁₋₄-alkyl or C₁₋₄-alkoxy;
p is 2, 3 or 4; and
q is an integer from 0 to 3;
or wherein the isocyanate having at least 2 isocyanate groups is a compound having the formula (IV): 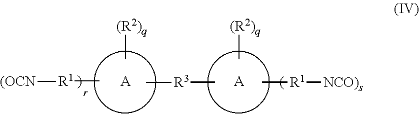
wherein:
each A is independently aryl, heteroaryl, cycloalkyl or heterocycloalkyl;
each R¹ is independently a covalent bond or C₁₋₄-alkylene;
each R² is independently halogen, C₁₋₄-alkyl or C₁₋₄-alkoxy;
R³ is a covalent bond, a C₁₋₄-alkylene or a group —(CH₂)_{R31}—O—(CH₂)_{R32}—, wherein R31 and R32 are each independently 0, 1, 2 or 3;
each q is independently an integer from 0 to 3; and
r and s are each independently 0, 1, 2, 3 or 4, wherein the sum of r and s is 2, 3 or 4.

7. The process according to claim 1, wherein the isocyanate with at least 2 isocyanate groups is selected from toluene-2,4-diisocyanate, toluene-2,6-diisocyanate, 1,5-naphthalenediisocyanate, cumene-2,4-diisocyanate, 4-methoxy-1,3-phenyldiisocyanate, 4-chloro-1,3-phenyldiisocyanate, diphenylmethane-4,4-diisocyanate, diphenylmethane-2,4-diisocyanate, diphenylmethane-2,2-diisocyanate, 4-bromo-1,3-phenyldiisocyanate, 4-ethoxy-1,3-phenyldiisocyanate, 2,4′-diisocyanatediphenylether, 5,6-dimethyl-1,3-phenyldiisocyanate, 2,4-dimethyl-1,3-phenyldiisocyanate, 4,4-diisocyanatodiphenylether, 4,6-dimethyl-1,3-phenyldiisocyanate, 9,10-anthracenediisocyanate, 2,4,6-toluenetriisocyanate, 2,4,4′-triisocyanatodiphenylether, 1,4-tetramethylenediisocyanate, 1,6-hexamethylenediisocyanate, 1,10-decamethylene-diisocyanate, 1,3-cyclohexylenediisocyanate, 4,4′-methylene-bis-(cyclohexylisocyanate), xylenediisocyanate, 1-isocyanato-3-methylisocyanate-3,5,5-trimethylcyclohexane, 1-3-bis(isocyanato-1-methylethyl)benzene, 1,4-bis(isocyanato-1-methylethyl)benzene, oligomers or polymers thereof, or mixtures thereof.

8. The process according to claim 1, wherein x is within the range of about 150% to about 350% of the isocyanate value.

9. The process according to claim 1, wherein in step (a) one or more additives are mixed with the proppant, the polyol component and the isocyanate component.

10. The process according to claim 1, wherein step (a) is carried out at a temperature of about 40° C. to about 150° C.

11. The process according to claim 1, wherein the water content of the mixture obtained in step (a) is less than 10 wt.-%, based on the total weight of the mixture as 100 wt.-%.

12. The process according to claim 1, wherein the catalyst in step (b) is selected from nitrogen-containing compounds, organometallic compounds or combinations thereof.

13. The process according to claim 12, wherein the catalyst is an amine, an organotin compound or a combination thereof.

14. The process according to claim 13, wherein the amine is a compound having the formula (R)₃N, wherein R is independently a (C₁₋₆)-hydrocarbon group optionally substituted with one or more hydroxy groups.

15. The process according to claim 13, wherein the amine is selected from trimethylamine, triethylamine, dimethylethylamine, dimethylisopropylamine, dimethylpropylamine, triethanolamine, vinylimidazole, 1,4-diazabicyclo[2.2.2]octane or a mixture thereof.

16. The process according to claim 13, wherein the organotin compound is a compound of the formula (R¹)₂Sn(R²)₂, wherein each R¹ is independently a (C₁₋₂₀)-hydrocarbon-carbonyloxy group and each R² is independently a (C₁₋₈)-hydrocarbon group.

17. The process according to claim 13, wherein the organotin compound is dibutyltin dilaurate.

18. The process according to claim 1, wherein, in step (b), a gaseous catalyst is applied to the mixture obtained in step (a), wherein the catalyst is optionally a nitrogen-amine mixture or an air-amine mixture, wherein the amine is optionally selected from trimethylamine, triethylamine, dimethylethylamine, dimethylpropylamine, dimethylisopropylamine or a mixture thereof.

19. The process according to claim 1, wherein the curing in step (b) is carried out at a temperature of about 60° C. to about 140° C.

20. The process according to claim 1, wherein the curing in step (b) is carried out at a pressure of about 50 kPa to about 200 kPa.

21. The process according to claim 1, wherein in step (c) the steps (a) and (b) are repeated one to five times.

22. A coated proppant, obtainable by the process according to claim 1.

23. Use of the coated proppant according to claim 22 in the production of crude oil or natural gas.

24. Frac liquid comprising the coated proppant according to claim 22.

25. A process for producing crude oil or natural gas, comprising introducing the frac liquid according to claim 24 into a rock layer containing crude oil or natural gas.

26. The process according to claim 25, wherein the introduction of the coated proppant causes the formation of a frac in the rock layer containing crude oil or natural gas and the coated proppant undergoes postcuring in the frac.

27. The process according to claim 26, wherein the coated proppant undergoes postcuring in the frac at a pressure in the range of about 690 to about 100,000 kPa, a temperature in the range of about 50 to about 250° C. and in the presence of water.

28. The process according to claim 25, wherein the frac liquid comprises water gelled with polymer, an oil-in-water emulsion gelled with polymer or a water-in-oil emulsion gelled with polymer.
